(19) United States
(12) Patent Application Publication
(10) Pub. No.: US 2005/0279793 A1
(43) Pub. Date: Dec. 22, 2005

(54) Tailgate divider

(75) Inventor: James Mulvihill, Royal Oak, MI (US)

Correspondence Address: LEAR CORPORATION, BLISS MCGLYNN, P.C., 2075 WEST BIG BEAVER ROAD, SUITE 600, TROY, MI, 48084, US

(73) Assignee: Lear Corporation

(21) Appl. No.: 10/860,914

(22) Filed: Jun. 4, 2004

(51) Int. Cl. B60R 9/00; B60R 11/00; B60R 7/00

(52) U.S. Cl. 224/542; 224/543

(57) ABSTRACT

A cargo management system for a motor vehicle with at least one seat well comprising a divider capable of fitting into the seat well and having two positions, stowed or deployed. This divider provides a lightweight, easy to use, unique storage management system for seat wells, a part of the vehicle which normally would not be an ideal storage area.

### FIELD OF INVENTION

This invention relates to the seat well space of a motor vehicle. More specifically, it relates to a cargo management system utilizing the seat well space for a motor vehicle.

### BACKGROUND OF INVENTION

Motors vehicles are generally equipped with areas for cargo storage. Some vehicles are equipped with trunk space, while others are equipped with storage areas behind the last row of seating. Consumer demand has driven the need to design motor vehicles with adequate cargo storage areas. However, with this demand comes the need for cargo management systems.

Many times, loose or smaller items are stored in the cargo space. While the vehicle is in motion, these loose or smaller items tend to move or roll around in the cargo space. This is undesirable because the items might be damaged or cause damage to the vehicle. As a result, systems have been developed to manage the cargo space and control items that are placed in that space.

While these systems have been effective in managing trunk space or the space behind the last row of seats, none have been able to manage the space that seat wells create. Some motor vehicles now allow for seats to be folded and stowed in the floor of the vehicle. When the seats are deployed, a seat well is left open and empty. When the seats are deployed, this seat well makes an ideal area to store cargo. However, the cargo, if just placed in the seat well, would roll around if not contained somehow. This invention solves the problem of cargo not being secured when stored. This lightweight, stiff yet pliable divider solves the problem of cargo storage within a seat well in an easy and cost-effective manner.

### SUMMARY OF INVENTION

This invention relates to a cargo management system for a motor vehicle with at least one seat well comprising a divider capable of fitting in said at least one seat well and having two positions, stowed or deployed. This divider comprises a stiff, yet pliable material.

The divider is capable of being deployed when the seat in a motor vehicle is deployed. A deployed seat leaves open a seat well in which the divider fits in. The divider height, while deployed, does not exceed the depth of the seat well.

When a user no longer has a need for the divider or the seats must be stowed, the divider can also be stowed. It can be stowed in a pouch on the tailgate of the motor vehicle.

This invention provides a unique storage management system for seat wells, a part of a vehicle which normally would not be an ideal storage area.

### DETAILED DESCRIPTION OF THE DRAWINGS

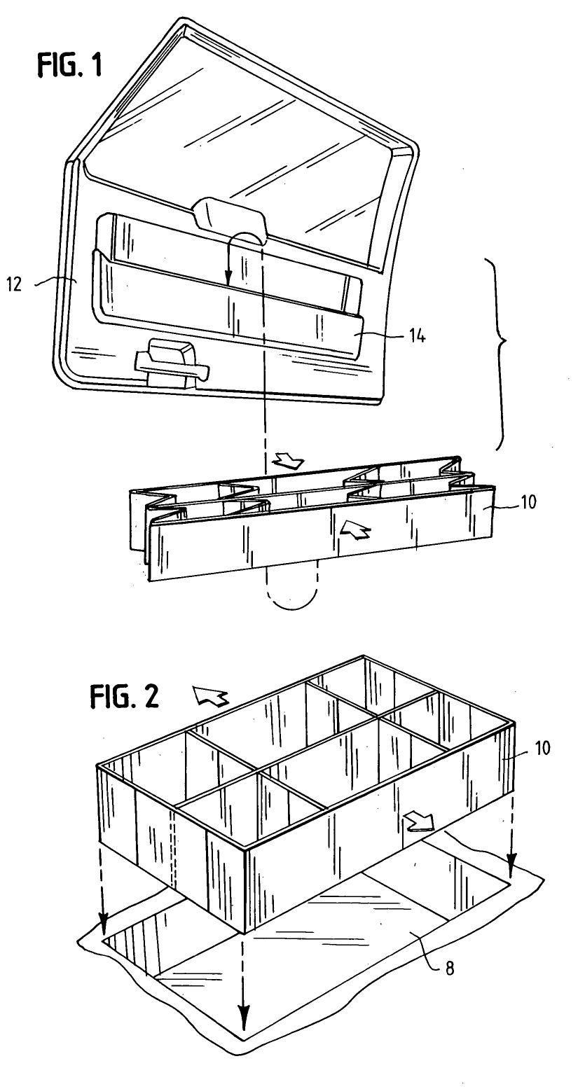

FIG. 1 depicts the divider in a folded position capable of being stowed in the pouch on the tailgate.

FIG. 2 depicts the divider in its deployed position being fitted into the seat well.

### DETAILED DESCRIPTION OF THE PREFERRED EMBODIMENT

This cargo management system for a motor vehicle having at least one seat well 8 comprises a divider 10 capable of fitting in said at least one seat well 8. This divider 10 has two positions. It is either stowed or it is deployed. The divider 10 comprises of a stiff yet pliable material. This divider 10 needs to be somewhat stiff so that it can keep its form and adequately support anything stored within it. However, the divider 10 also needs to be pliable so that it can be folded and stowed.

When not in use, this divider 10 is folded and held in a pouch 14 on the tailgate 12, as seen in FIG. 1. The divider 10 should be held in this position if the user desires to stow the seats, thereby eliminating the empty seat well 8 or when large cargo must be placed in the seat well 8.

The divider 10 is deployed when the user removes it from its stowed position in the pouch 14 on the tailgate 12 and unfolds it and places it into the seat well 8, as seen in FIG. 2. The divider 10 fits into the seat well 8 and its height should not exceed the depth of the seat well 8. This is so that the floor of the vehicle can remain fairly level. While the divider 10 is deployed a user may place loose items in it and they will be safety contained. Items will not be able to roll and will not be damaged since they are safely contained.

The above presents a description of the best mode contemplated for carrying out this invention. The claims should not be read as limited to the described order or elements unless stated to that effect. Therefore, all embodiments that come with the scope and spirit of the following claims and equivalents thereto are claimed as the invention.

1. A cargo management system for a motor vehicle with at least one seat well comprising:
a divider capable of fitting in said at least one seat well and having two positions, stowed or deployed.

2. A cargo management system for a motor vehicle with at least one seat well as in claim 1, wherein said divider comprises a stiff yet pliable material.

3. A cargo management system for a motor vehicle with at least one seat well as in claim 1, wherein said divider is capable of being deployed when seat in motor vehicle is deployed freeing said seat well for said divider.

4. A cargo management system for a motor vehicle with at least one seat well as in claim 1, wherein said divider is stowed in a pouch on the tailgate of the motor vehicle when said divider is not needed.

5. A cargo management system for a motor vehicle with at least one seat well as in claim 1 wherein said divider height does not exceed depth of seat well.

6. A vehicle interior for a vehicle comprising:
at least one seat well defining a recessed space within the vehicle; and
a divider removably supported within said seat well so as to divide said recessed space defined by the seat well.

7. A vehicle interior as set forth in claim 6 wherein said divider includes a plurality of walls, and wherein said divider can be positioned in a deployed position in which said walls are substantially disposed in spaced relationship to each other, and a stowed position, in which said walls are substantially adjacent each other such that said divider is substantially flat.

8. A vehicle interior as set forth in claim 7 wherein said divider includes a plurality of axial walls and a plurality of transverse walls that are substantially perpendicular to said axial walls when said divider is in the deployed position, and wherein at least one of said axial walls and said transverse walls folds such that the other of said axial walls and said transverse walls move towards each other when said divider moves away from the deployed position and toward the stowed position.

9. A vehicle interior as set forth in claim 7 further comprising a pouch in which said divider can be stored when said divider is in the stowed position.

10. A vehicle interior as set forth in claim 6 wherein the height of the divider does not exceed the height of said recessed spaced defined by said seat well.

11. A vehicle interior as set forth in claim 6 wherein said divider is made of a stiff yet pliable material.

12. A vehicle interior as set forth in claim 6 further comprising a seat adapted to be removably positioned within said seat well.
